(19) United States
(12) Patent Application Publication
(10) Pub. No.: US 2024/0248946 A1
(43) Pub. Date: Jul. 25, 2024

(54) LOCAL DYNAMIC PAGE GENERATION METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Xing YANG, Shenzhen (CN); Honghui TAO, Shenzhen (CN); Guohui ZHENG, Shenzhen (CN)

(21) Appl. No.: 18/624,643

(22) Filed: Apr. 2, 2024

Related U.S. Application Data
(63) Continuation of application No. PCT/CN2023/096236, filed on May 25, 2023.

(30) Foreign Application Priority Data
Aug. 9, 2022 (CN) 202210949924.0

(51) Int. Cl. G06F 16/958; H04N 21/431

(52) U.S. Cl. CPC G06F 16/972; H04N 21/431

(57) ABSTRACT

A local dynamic page generation method includes: receiving a service package name of target information delivered by an operation platform, the service package name being configured and generated according to configuration information of the target information; receiving an information display request transmitted by a terminal; acquiring attribute information of the terminal; parsing, when the attribute information of the terminal matches the target information, fields in the service package name in response to the information display request, to obtain the configuration information; and invoking a local dynamic component corresponding to the configuration information to load the target information to a local display region on a current page of the terminal, to generate a local dynamic page.

### RELATED APPLICATIONS

This application is a continuation application of PCT Patent Application No. PCT/CN2023/096236, filed on May 25, 2023, which claims priority to Chinese Patent Application No. 202210949924.0 filed on Aug. 9, 2022, both of which are incorporated herein by reference in their entirety.

### FIELD OF THE TECHNOLOGY

Embodiments of the present disclosure relate to the field of Internet technologies, and relate to, but not limited to, a local dynamic page generation method and apparatus, an electronic device, a computer-readable storage medium, and a computer program product.

### BACKGROUND

At present, in order to meet the needs of rapid iteration, a growing number of applications (APPs) use dynamic technology (e.g., active server page) on some pages with relatively high real-time requirements. A dynamic framework is usually used to realize global dynamization of the entire page, or a “secondary dynamization” solution is used to realize a local dynamic display solution.

However, global dynamization mostly occupies the entire terminal page, and in the dynamization technology, a JavaScript language is used to operate native controls. Cross-language inevitably brings some performance overhead, causing performance of global dynamization to be slightly worse than that of the native technology. The local dynamization achieved by using the “secondary dynamization” solution is to use a “tag” for place-holding at a certain local position of the terminal, and then use a front-end development package to perform dynamical filling. The name of the front-end development package cannot be dynamically configured and modified by operation, and because a dynamic component is fixed at a local position on a page of the terminal, there is no way to remove the dynamic component herein by skipping delivering the name of the front-end development package, so that there is no good dynamic configurable and pluggable features, and requirements cannot be met in some scenarios that require relatively high flexibility for whether to display an advertisement. It can be seen that, during generation of a dynamic page by using the dynamic technology, there are problems of low flexibility in page information configuration and poor overall smoothness of the page.

### SUMMARY

Embodiments of the present disclosure provide a local dynamic page generation method and apparatus, an electronic device, a computer-readable storage medium, and a computer program product, which are applied at least to the field of artificial intelligence and the field of page development, and can ensure that a local dynamic page is flexibly generated based on that the entire page is developed through native components, to ensure the flexibility of page information configuration and the overall smoothness of the page, thereby enhancing the diversity and the flexibility in operating placed information within the application.

The technical solutions of the embodiments of the present disclosure are implemented as follows:

An embodiment of the present disclosure provides a local dynamic page generation method, performed by an electronic device, the method including: receiving a service package name of target information delivered by an operation platform, the service package name being configured and generated according to configuration information of the target information; receiving an information display request transmitted by a terminal; acquiring attribute information of the terminal; parsing, when the attribute information of the terminal matches the target information, fields in the service package name in response to the information display request, to obtain the configuration information; and invoking a local dynamic component corresponding to the configuration information to load the target information to a local display region on a current page of the terminal, to generate a local dynamic page.

An embodiment of the present disclosure provides a local dynamic page generation apparatus, including: a first receiving module, configured to receive a service package name of target information delivered by an operation platform, the service package name being configured and generated according to configuration information of the target information; a second receiving module, configured to receive an information display request transmitted by a terminal, and acquire attribute information of the terminal; a field parsing module, configured to parse, when the attribute information of the terminal matches the target information, fields in the service package name in response to the information display request, to obtain the configuration information; and an information loading module, configured to invoke a local dynamic component corresponding to the configuration information to load the target information to a local display region on a current page of the terminal, to generate a local dynamic page.

An embodiment of the present disclosure provides an electronic device, including: at least one memory, configured to store executable instructions; and at least one processor, configured to implement, when executing the executable instructions stored in the at least one memory, the foregoing local dynamic page generation method.

An embodiment of the present disclosure provides a computer

An embodiment of the present disclosure provides a non-transitory computer-readable storage medium, storing executable instructions, and configured to implement, when causing a processor to execute the executable instructions, the foregoing local dynamic page generation method.

The embodiments of the present disclosure have the following beneficial effects: An operation platform configures and generates a service package name of target information according to configuration information of the target information, and delivers the service package name to an application server of an application, and the application server receives an information display request transmitted by a terminal; when the application server has received the service package name of the target information and attribute information of the terminal matches the target information, fields in the service package name are parsed in response to the information display request, to obtain the configuration information; and a local dynamic component corresponding to the configuration information is invoked to load the target information to a local display region on a current page of the terminal, to generate a local dynamic page. In this way, because the service package name of the target information is configured through the operation platform, the flexibility of page information configuration can be ensured; and information in the local display region on the entire page is configured, that is, local display information is configured to invoke the local dynamic component to load local dynamic content based on that the entire page is developed through native components, which can not only ensure the overall smoothness of the page, but also can flexibly generate the local dynamic page, thereby enhancing the diversity and the flexibility in operating placed information within the application.

### BRIEF DESCRIPTION OF THE DRAWINGS

FIG. 1 is an APP page developed based on a dynamic framework in the related art.

FIG. 2 is a schematic diagram of a local dynamic page display method in the related art.

FIG. 3 is an exemplary schematic architectural diagram of a local dynamic page generation system according to an embodiment of the present disclosure.

FIG. 4 is a schematic structural diagram of an electronic device according to an embodiment of the present disclosure.

FIG. 5 is an exemplary schematic flowchart of a local dynamic page generation method according to an embodiment of the present disclosure.

FIG. 6 is another exemplary schematic flowchart of a local dynamic page generation method according to an embodiment of the present disclosure.

FIG. 7 is still another exemplary schematic flowchart of a local dynamic page generation method according to an embodiment of the present disclosure.

FIG. 8 is a schematic diagram of a local dynamic advertisement displayed in a pop-up window according to an embodiment of the present disclosure.

FIG. 9 is a schematic diagram of a request interaction process between an operation platform and an APP according to an embodiment of the present disclosure.

FIG. 10 is a schematic diagram of display logic of a terminal according to an embodiment of the present disclosure.

FIG. 11 is a schematic diagram of a principle for a terminal to load a front-end data package according to an embodiment of the present disclosure.

FIG. 12 is a schematic diagram of different types of control experiments of a local dynamic page generation method according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. Unless otherwise defined, meanings of all technical and scientific terms used in the embodiments of the present disclosure are the same as those usually understood by a person skilled in the art to which the embodiments of the present disclosure belongs. Terms used in the embodiments of the present disclosure are merely intended to describe the embodiments of the present disclosure, but are not intended to limit the present disclosure.

Before embodiments of the present disclosure are explained, technical terms involved in the embodiments of the present disclosure are first described.
(1) Configurable: It means that an operator can configure and deliver data in a configuration system, and a client can trigger pull logic under certain conditions and acquire corresponding configuration data, to perform logic such as user interface (UI) display.
(2) Dynamization: The rapid iteration of products is inseparable from the support of the dynamic capabilities of mobile terminals. Dynamization refers to the capability to dynamically deploy and deliver logic to the client, to make the development of mobile terminal applications like that of web pages, and the App release cycle can be bypassed, to achieve rapid release.
(3) Local dynamization: It refers to achieving dynamization in a certain part of the terminal page, so that the overall performance of the page remains consistent with that of the native page.
(4) Pluggable: In the dynamic advertising service, the pluggable capability means that the dynamic advertisement may be opened by delivering a resource of an interactive type, or may be closed by skipping delivering a resource of an interactive type.
(5) Interactive: It means that a user can perform a series of interactive operations on an advertising page, and the page can respond to this series of interactive operations; and the interactive capability is usually achieved by developing a dynamic page.
(6) H5: It refers to the abbreviation of the HyperText Markup Language 5 (HTML5) web page technology, which is the mainstream language for current Internet front-end development. When an H5 page is compared with ordinary Web pages, the biggest difference is that the HTML5 page can match mobile devices of different sizes and support compatibility with different browsers on the market.
(7) JavaScript: It is a programming language for the Web. HTML pages can all use JavaScript, where the HTML language defines content of the web page, and JavaScript controls behaviors of the web page.
(8) JS bundle: The front-end source code is packaged and compiled through a command line, and finally a bundle file is outputted. This bundle file contains a final source file that has been loaded and compiled and may be run directly in a browser.

Before the local dynamic page generation method in the embodiments of the present disclosure is explained, the method in the related art is first described.

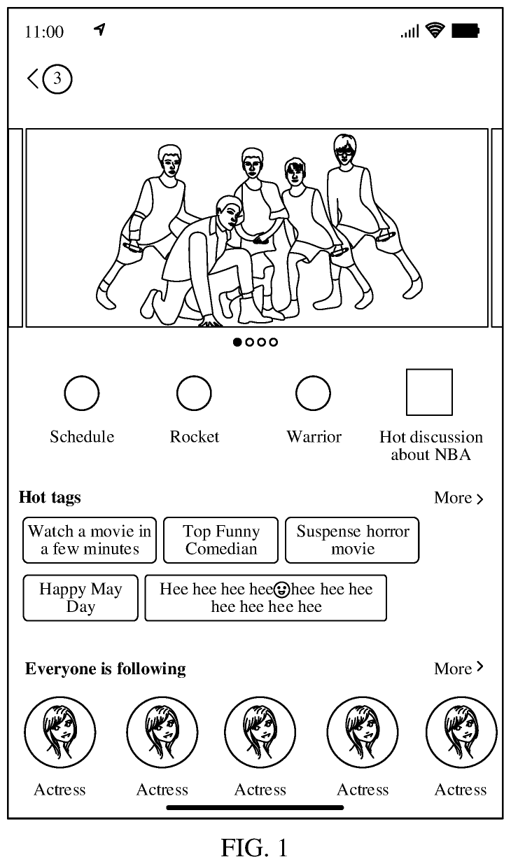

Currently, many pages on APPs use dynamic frameworks to achieve global dynamization of the entire pages. Most of these global dynamic pages are implemented through the H5 technology. A developer can write an APP interface like writing a Web page in the development environment, and then use a command line tool to compile the APP interface into a piece of JavaScript code to generate a JS data package (JS bundle). In a client of a mobile application, the engine prepares a JavaScript execution environment in advance, the corresponding JS bundle is executed in the execution environment of the opened page, and various commands generated during the execution are transmitted to a terminal for page rendering, data storage, invoking terminal device functions, and the like, where the page displayed is a normal terminal page (as shown in FIG. 1, it is an APP page developed based on a dynamic framework in the related art). However, sometimes an advertising space on the APP is realized without the technology for dynamization of the entire page, provided that a certain local position can be dynamically displayed.

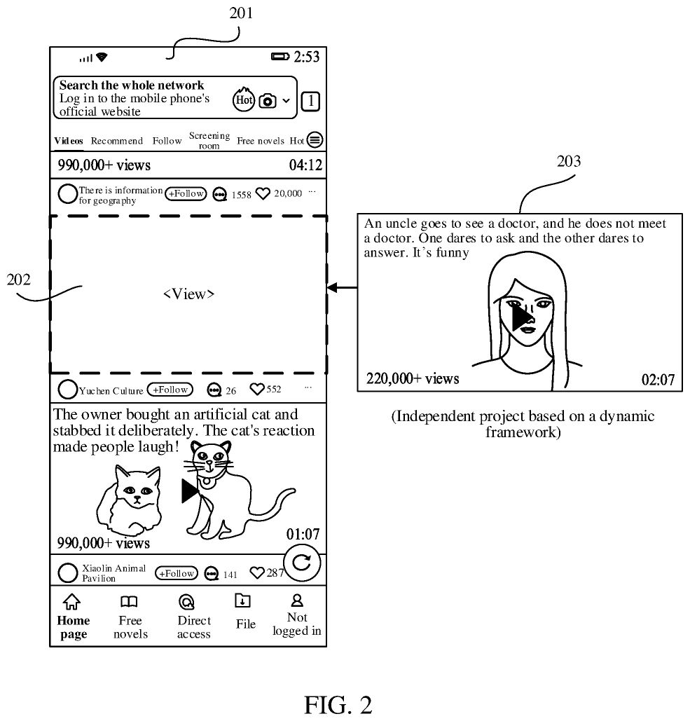

Therefore, many display solutions for local dynamization of terminals have emerged. Most of these solutions are implemented with a “secondary dynamic” solution, which uses the implementation idea of “performing place-holding first and performing filling later” to use a “tag” for place-holding at a certain local position of the terminal, and then use a front-end development package to perform dynamic filling. FIG. 2 is a schematic diagram of a local dynamic page display method in the related art. A view tag is used for place-holding at a local position 202 on an APP page 201, and then a front-end development package 203 is used to perform dynamic filling. The name of the front-end development package cannot be dynamically configured and modified by operation, and because a dynamic component is fixed at a local position on a page of the terminal, there is no way to remove the dynamic component herein by skipping delivering the name of the front-end development package, so that there is no good dynamic configurable and pluggable features, and requirements cannot be well met in some scenarios that require relatively high flexibility for whether to display an advertisement.

In the related art, global dynamization mostly occupies the entire terminal page, and in the dynamization technology, a JavaScript language is used to operate native controls. Cross-language inevitably brings some performance overhead, causing the performance to be slightly worse than that of the native technology. Some main scenarios of the APP have extremely high requirements for the smoothness of the entire pages. These pages are still mainly native development pages at present. In addition, there are some operation positions in the APP for delivering advertisements and notifications. The content of these scenarios is generally dynamically controlled by operation, which not only requires the content of these local advertisements to be dynamic, but also has extremely high requirements on the pluggability of these advertisements. In order to comprehensively optimize the terminal performance experience and dynamic capabilities, this local dynamic solution may be adopted. The content of these advertisements does not need to be displayed on the entire page, but only need to be displayed on a certain local part of the page, and the displayed service content and whether to display the service content may also be dynamically configured by the operation. This solution can keep the overall smoothness of the page consistent with that of the native development page, and the dynamic technology is only used in places requiring dynamization, thereby reducing the impact of dynamization on the performance, and providing a high degree of flexibility in advertising configuration.

Based on the problems existing in the related art, embodiments of the present disclosure provide a local dynamic page generation method. The method is a method of local dynamic advertising display based on a cross-platform framework, in which a dynamic component is used at any local position in the APP service for place-holding, and then service code is written through the dynamic framework to dynamically update the content in the component. In this way, the operation can determine the service content displayed on the terminal by configuring the package name of the JS bundle (that is, a service package name of to-be-recommended information), thereby flexibly replacing and updating the content of the local dynamic component. In addition, because the dynamic component is only used at a local position, and the entire page is still developed with native components, the overall experience of the page is close to that of the native development page, making a user obtain a good experience.

In the local dynamic page generation method provided in the embodiments of the present disclosure, first, a service package name of to-be-recommended information delivered by an operation platform is received, the service package name being configured and generated according to configuration information of the to-be-recommended information; an information display request transmitted by a terminal is received; attribute information of the terminal is acquired; when the attribute information of the terminal matches the to-be-recommended information, fields in the service package name are parsed in response to the information display request, to obtain the configuration information; and a local dynamic component corresponding to the configuration information is invoked to load the to-be-recommended information to a local display region on a current page of the terminal, to generate a local dynamic page. In this way, because the service package name of the to-be-recommended information is configured through the operation platform, the flexibility of page information configuration can be ensured; and information in the local display region on the entire page is configured, that is, local display information is configured to invoke the local dynamic component to load local dynamic content based on that the entire page is developed through native components, which can not only ensure the overall smoothness of the page, but also can flexibly generate the local dynamic page, thereby enhancing the diversity and the flexibility in operating placed information within the application.

The following describes an exemplary application of a local dynamic page generation device in the embodiments of the present disclosure. The local dynamic page generation device provided in the embodiments of the present disclosure is an electronic device configured to implement the local dynamic page generation method. In an implementation, the local dynamic page generation device (that is, electronic device) provided in the embodiments of the present disclosure may be implemented as a server, and the server may be a server for any application. The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal and the server may be directly or indirectly connected in a wired or wireless communication manner. This is not limited in the embodiments of the present disclosure. An exemplary application when the local dynamic page generation device is implemented as a server will be described below.

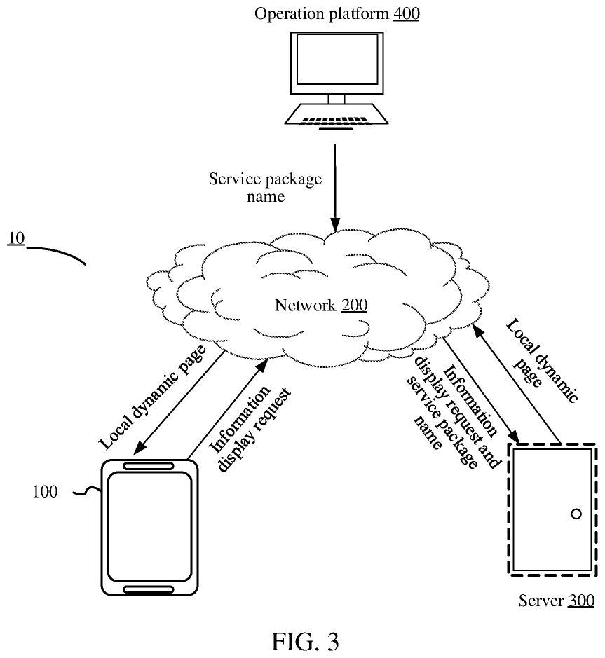

FIG. 3 is an exemplary schematic architectural diagram of a local dynamic page generation system according to an embodiment of the present disclosure. In the embodiments of the present disclosure, a description is made by using an example in which the local dynamic page generation method is applied to an instant messaging application for local dynamic page generation in the application. To support any instant messaging application, at least an instant messaging application is installed on the terminal in the embodiments of the present disclosure, and different application interfaces can be displayed through the instant messaging application.

In this embodiment of the present disclosure, the local dynamic page generation system 10 includes at least a terminal 100, a network 200, a server 300, and an operation platform 400. The server 300 is a server for an instant messaging application, and the operation platform 400 is a configuration platform on an operation side, configured to provide an information configuration platform to an operator, so that the operator configures a service package name of to-be-recommended information on the operation platform. The server 300 may constitute the local dynamic page generation device in the embodiments of the present disclosure. The terminal 100 is connected to the server 300 by the network 200, and the server 300 is connected to the operation platform 400 by the network. The network 200 may be a wide area network or a local area network, or a combination thereof. Before running the instant messaging application and generating a local dynamic page, the operator configures and generates a service package name of to-be-recommended information according to configuration information of the to-be-recommended information, and delivers the service package name to the server 300. In the process of running the instant messaging application, the server 300 receives an information display request transmitted by the terminal 100; if the server 300 determines that attribute information of the terminal matches the to-be-recommended information, the server 300 parses fields in the service package name in response to the information display request, to obtain the configuration information; and invokes a local dynamic component corresponding to the configuration information to load the to-be-recommended information to a local display region on a current page of the terminal 100, to generate a local dynamic page. The terminal 100 displays the local dynamic page on the current interface.

The local dynamic page generation method provided in the embodiments of the present disclosure may alternatively be implemented based on a cloud platform and through the cloud technology. For example, the server 300 may be a cloud server. A service package name of to-be-recommended information delivered by the operation platform is received through the cloud server, or an information display request transmitted by the terminal is received through the cloud server, or fields in the service package name are parsed in response to the information display request through the cloud server, to obtain the configuration information, and a local dynamic component corresponding to the configuration information is invoked through the cloud server to load the to-be-recommended information to a local display region on a current page of the terminal, to generating a local dynamic page, and the like.

In some embodiments, there may alternatively be a cloud storage, and the service package name of the to-be-recommended information may be stored in the cloud storage, or the local dynamic page may also be stored in the cloud storage, or a target video may also be stored in the cloud storage. In this way, when the page is displayed on the current interface, the local dynamic page may be acquired from the cloud storage for display.

The cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A background service of a technical network system requires a large amount of computing and storage resources, such as video websites, image websites, and more portal websites. As the Internet industry is highly developed and applied, each article may have its own identifier in the future and needs to be transmitted to a background system for logical processing. Data at different levels is separately processed, and data in various industries requires strong system support, which can only be implemented through cloud computing.

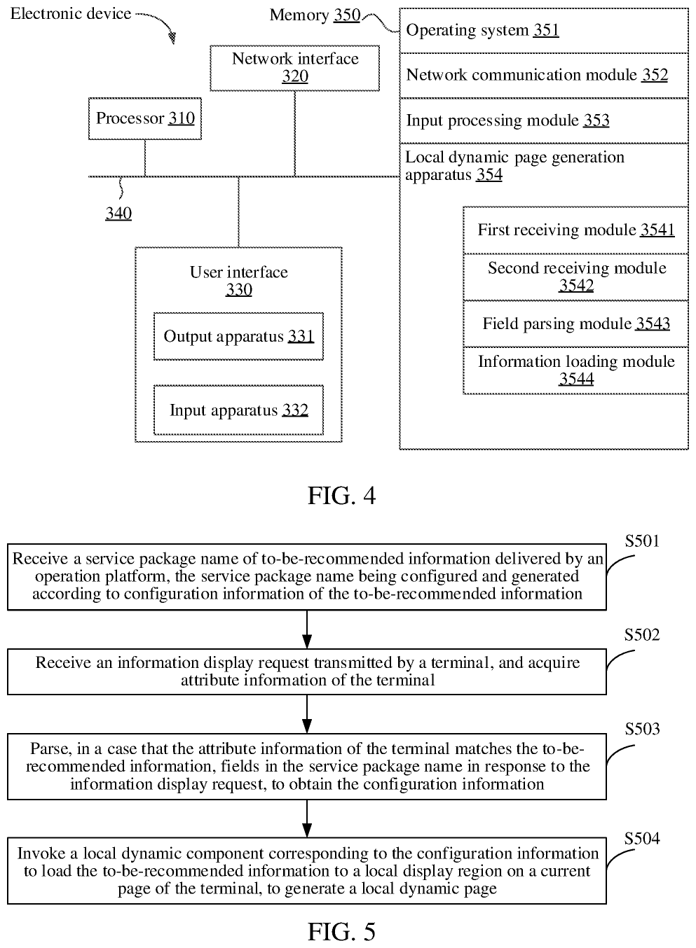

FIG. 4 is a schematic structural diagram of an electronic device according to an embodiment of the present disclosure. The electronic device shown in FIG. 4 includes: at least one processor 310, a memory 350, at least one network interface 320, and a UI 330. The components in the electronic device are coupled by using a bus system 340. It may be understood that the bus system 340 is configured to implement connection and communication between the components. In addition to a data bus, the bus system 340 further includes a power bus, a control bus, and a status signal bus. However, for ease of clear description, all types of buses are marked as the bus system 340 in FIG. 4.

The processor 310 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any processor, or the like. The UI 330 includes one or more output apparatuses 331 that can present media content, and one or more input apparatuses 332.

The memory 350 may be a removable memory, a non-removable memory, or a combination thereof. Exemplary hardware devices include a solid-state memory, a hard disk drive, an optical disc driver, or the like. The memory 350 may include one or more storage devices that are physically away from the processor 310. The memory 350 includes a volatile memory or a non-volatile memory, or may include both a volatile memory and a non-volatile memory. The non-volatile memory may be a read-only memory (ROM). The volatile memory may be a random access memory (RAM). The memory 350 described in this embodiment of the present disclosure is to include any suitable type of memories. In some embodiments, the memory 350 can store data to support various operations. Examples of the data include a program, a module, and a data structure, or a subset or a superset thereof, which are described below by using examples.

An operating system 351 includes a system program configured to process various basic system services and perform a hardware-related task, for example, a framework layer, a core library layer, and a driver layer, and is configured to implement various basic services and process a hardware-related task.

A network communication module 352 is configured to reach another computing device through one or more (wired or wireless) network interfaces 320. Exemplary network interfaces 320 include: Bluetooth, wireless compatible authentication (WiFi), a universal serial bus (USB), and the like.

An input processing module 353 is configured to detect one or more user inputs or interactions from one of the one or more input apparatuses 332 and translate the detected input or interaction.

In some embodiments, the apparatus provided in the embodiments of the present disclosure may be implemented by using software. FIG. 4 shows a local dynamic page generation apparatus 354 stored in the memory 350. The local dynamic page generation apparatus 354 may be a local dynamic page generation apparatus in the electronic device, may be software in a form such as a program and a plug-in, and includes the following software modules: a first receiving module 3541, a second receiving module 3542, a field parsing module 3543, and an information loading module 3544. These modules are logical modules, and may be combined in different manners or further divided based on a function to be performed. The following describes functions of the modules.

In some other embodiments, the apparatus provided in the embodiments of the present disclosure may be implemented by using hardware. For example, the apparatus provided in the embodiments of the present disclosure may be a processor in a form of a hardware decoding processor, programmed to perform the local dynamic page generation method provided in the embodiments of the present disclosure. For example, the processor in the form of a hardware decoding processor may use one or more application-specific integrated circuits (ASIC), a DSP, a programmable logic device (PLD), a complex programmable logic device (CPLD), a field-programmable gate array (FPGA), or other electronic components.

The local dynamic page generation method provided in the embodiments of the present disclosure may be performed by an electronic device. The electronic device may be a server, that is, the local dynamic page generation method in the embodiments of the present disclosure may be performed by a server.

FIG. 5 is an exemplary schematic flowchart of a local dynamic page generation method according to an embodiment of the present disclosure. A description is made below with reference to the steps shown in FIG. 5. The local dynamic page generation method in FIG. 5 is described by using an example in which a server is used as an execution subject.

Step S501: Receive a service package name of to-be-recommended information (also referred as target information) delivered by an operation platform, the service package name being configured and generated according to configuration information of the to-be-recommended information.

In this embodiment of the present disclosure, the operation platform is a third-party platform that is independent of a terminal and the server. The operation platform is a platform for an operator to configure information. The operation platform has a configuration system, and the operator may configure and generate a service package name of each piece of to-be-recommended information in the configuration system. A plurality of applications may be run on the terminal. The local dynamic page generation method in this embodiment of the present disclosure may be applied to any target application installed on the terminal, or any service in the target application. For example, the target application may be an instant messaging application, an information recommendation application, a shopping application, or the like, and any local dynamic page in the instant messaging application may be generated through the local dynamic page generation method in this embodiment of the present disclosure.

The to-be-recommended information may be any type of information in the recommendation system. For example, the to-be-recommended information may be information of any type of a picture type, an animated picture type, a video type, an audio type, or an interactive type. The recommendation system may belong to the same system as the operation platform, may belong to the same system as the server of the target application, or may certainly be a third-party recommendation system that is independent of the operation platform and the server of the target application and configured to provide to-be-recommended information.

In an implementation, when the operator configures the service package name of the to-be-recommended information on the operation platform, the operator may first acquire the to-be-recommended information from the recommendation system, and then configure and generate the service package name based on attribute parameters of the to-be-recommended information. That is, the operation platform may acquire information content of the to-be-recommended information from the recommendation system, and simultaneously determine the attribute parameters of the to-be-recommended information based on the information content of the to-be-recommended information. The attribute parameters herein include, but not limited to, at least one of the following: a resource type and a resource address of the to-be-recommended information. For example, the resource type of the to-be-recommended information may be determined (that is, determine the to-be-recommended information is a picture resource, an animated picture resource, a video resource, or an interactive resource) based on the information content of the to-be-recommended information, and then the service package name of the to-be-recommended information is configured based on the resource type of the to-be-recommended information. In another implementation, when the operator configures the service package name of the to-be-recommended information on the operation platform, the operator may alternatively directly acquire the attribute parameters of the to-be-recommended information from the recommendation system, for example, acquire the resource type and the resource address of the to-be-recommended information, and then configure and generate the service package name based on the resource type and resource address of the to-be-recommended information.

In this embodiment of the present disclosure, configuring and generating the service package name according to the configuration information of the to-be-recommended information may be sequentially adding, in the field format of the service package name, the configuration information of the to-be-recommended information to specific positions in the field format. For example, for to-be-recommended information of different resource types, field values corresponding to the resource types of the to-be-recommended information may be added to positions corresponding to the resource types in the field format; and for to-be-recommended information of different resource addresses, the resource addresses of the to-be-recommended information may be added to positions corresponding to the resource addresses in the field format. In this way, a service package name with this field format can be formed.

In some embodiments, configuration of the service package name of the to-be-recommended information may be automatic configuration based on the field format, or may be manual configuration by the operator. During automatic configuration based on the field format, the configuration system may perform information identification on the to-be-recommended information, to determine the configuration information of the to-be-recommended information, and then automatically add the resource type and the resource address in the configuration information to corresponding positions in the field format respectively, to intelligently generate the service package name of the to-be-recommended information, thereby realizing active and automatic configuration of the service package name, and improving the configuration efficiency of the service package name of the to-be-recommended information in the recommendation system.

For different to-be-recommended information, field formats of service package names may be the same or different. The field formats of the service package names of different to-be-recommended information may be predefined. Alternatively, for to-be-recommended information of different recommendation systems, field formats of service package names may be different; and for to-be-recommended information of the same recommendation system, field formats of service package names may be the same. The field format of the service package name is a package name format of the service package name.

In some embodiments, after receiving the service package name of the to-be-recommended information delivered by the operation platform, the server of the target application may store the service package name. For example, a service package name library for storing service package names may be preset, and when a service package name of new to-be-recommended information delivered by the operation platform is received, the service package name of the new to-be-recommended information may be stored into the service package name library. In this way, during subsequent generation of a local dynamic page, it can be convenient to load the to-be-recommended information corresponding to the service package name to a local display region on the local dynamic page; and when a local dynamic page needs to be generated, an appropriate service package name can be screened/selected from the service package name library, to obtain corresponding to-be-recommended information, and load the screened to-be-recommended information to the local display region on the local dynamic page, thereby completing the information recommendation and display of the to-be-recommended information.

Step S502: Receive an information display request transmitted by a terminal, and acquire attribute information of the terminal.

Herein, the information display request is configured for requesting to display the to-be-recommended information on the terminal. The information display request may be a request generated through automatic triggering when the terminal receives a data processing operation entered by a target object on a client of the target application.

For example, a target application is run on the terminal. When the user performs a pull-down refresh operation or a login triggering operation in the target application, the terminal generates an information display request in response to the user's pull-down refresh operation or login triggering operation, and transmits the information display request to the server, to request the server to configure to-be-displayed information at a local display region on a current interface of the target application, that is, request the server to load to-be-recommended information matching the user at the local display region, thereby displaying a local dynamic page on the current interface to achieve accurate information recommendation to the user. The to-be-recommended information matching the user described herein may refer to information that conforms to the user's browsing habits or the user's interest in the to-be-recommended information is greater than an interest threshold, or may refer to to-be-recommended information with which that the user has a relatively high probability to interact.

Step S503: Parse, when the attribute information of the terminal matches the to-be-recommended information, fields in the service package name in response to the information display request, to obtain the configuration information.

Herein, after receiving the information display request from the terminal, the server analyzes the target object corresponding to the terminal, to determine an object feature of the target object, and performs, based on the object features of the target object, information recalling from to-be-recommended information corresponding to a plurality of service package names stored in the service package name library, to obtain to-be-recommended information matching the target object, that is, screens/selects to-be-recommended information matching the object feature of the target object from a plurality of pieces of to-be-recommended information. The selected to-be-recommended information is to-be-recommended information with which the target object has a relatively high probability to interact, that is, the target object's interaction probability for the selected to-be-recommended information is greater than a probability threshold.

During implementation, an interaction probability of the target object for interacting with each piece of to-be-recommended information may be determined based on the object feature of the target object, and to-be-recommended information of which the interaction probability is greater than the probability threshold is determined as the screened to-be-recommended information. In this embodiment of the present disclosure, any prediction model may be used to predict the interaction probability between the target object and the to-be-recommended information. The interaction provided in this embodiment of the present disclosure may be any interaction manner, for example, interaction manners such as clicking, commenting, sharing, purchasing, reading, and collecting.

In this embodiment of the present disclosure, after the to-be-recommended information is screened, it indicates that the attribute information of the terminal matches the to-be-recommended information. That is, that the attribute information of the terminal matches the to-be-recommended information means that the interaction probability between the target object corresponding to the terminal and the to-be-recommended information is greater than the probability threshold. In this case, the service package name of the to-be-recommended information may be acquired, and fields in the service package name may be parsed in response to the information display request, to obtain the configuration information of the to-be-recommended information.

Parsing the fields in the service package name may be identifying fields at different field positions in the service package name to obtain identification results, and then determining information corresponding to the field positions based on the field positions and the identification results. For example, a field at a resource type field position may be identified, to obtain a field value corresponding to the resource type, and then the resource type of the to-be-recommended information may be determined based on the field value corresponding to the resource type; or a field at a resource address field position may be identified, to obtain the resource address of the to-be-recommended information, and then the resource of the to-be-recommended information may be directly acquired based on the resource address.

Step S504: Invoke a local dynamic component corresponding to the configuration information to load the to-be-recommended information to a local display region on a current page of the terminal, to generate a local dynamic page.

In this embodiment of the present disclosure, the local display region refers to a partial region on the current page of the target application on the terminal. The local display region may be located at any position on the current page, for example, may be located at a top position, a bottom position, a left edge position, a right edge position, or a central position on the current page. The local display region may have a fixed size and shape, or may have an unfixed size and shape. For example, the local display region may have half of the current page area, or ⅓ of the current page area, and may be a rectangular region, a square region, a circular region, a star-shaped region, or an irregular-shaped region.

A plurality of types of local dynamic components may be correspondingly configured for the local display region, and each local dynamic component is configured to perform information loading processing on one type of to-be-recommended information. For example, there may be a picture component, an animated picture component, a player component, and a dynamic component, which are respectively configured to load to-be-recommended information of a picture type, an animated picture type, a video type, and a dynamic type. Herein, loading the to-be-recommended information to the local display region on the current page of the terminal means rendering content corresponding to the to-be-recommended information into the local display region, thereby forming a local dynamic page containing the information content of the to-be-recommended information in the local display region.

In some embodiments, there may be a plurality of local display regions on the current page of the terminal. During information recommendation on the current to-be-recommended information, one local display region configured for displaying the to-be-recommended information may be specified in advance, or one or more local display regions configured for displaying the to-be-recommended information may be determined based on the information content of the to-be-recommended information.

In some embodiments, when the attribute information of the terminal does not match the to-be-recommended information, or the service package name of the to-be-recommended information that matches the attribute information of the terminal is not found from the service package name library, the to-be-recommended information may not be recommended, that is, the to-be-recommended information is not rendered in the local display region on the current page. In this case, the existing content on the current page may be displayed in the local display region, or no content is displayed in the local display region. That is, no local dynamic component may be invoked for information loading. In this way, the pluggable characteristic of the local dynamic component of the local display region of the terminal is realized.

According to the local dynamic page generation method provided in this embodiment of the present disclosure, an operation platform configures and generates a service package name of to-be-recommended information according to configuration information of the to-be-recommended information, and delivers the service package name to an application server of an application, and the application server receives an information display request transmitted by a terminal; when the application server has received the service package name of the to-be-recommended information and attribute information of the terminal matches the to-be-recommended information, fields in the service package name are parsed in response to the information display request, to obtain the configuration information; and a local dynamic component corresponding to the configuration information is invoked to load the to-be-recommended information to a local display region on a current page of the terminal, to generate a local dynamic page. In this way, because the service package name of the to-be-recommended information is configured through the operation platform, the flexibility of page information configuration can be ensured; and information in the local display region on the entire page is configured, that is, local display information is configured to invoke the local dynamic component to load local dynamic content based on that the entire page is developed through native components, which can not only ensure the overall smoothness of the page, but also can flexibly generate the local dynamic page, thereby enhancing the diversity and the flexibility in operating placed information within the application.

In some embodiments, the local dynamic page generation system includes at least: a terminal, an application server, and an operation platform. Any target application with a local dynamic page generation function, such as an instant messaging application, an information recommendation application, or a shopping application, is installed on the terminal. In this embodiment of the present disclosure, a description is made by using an example in which an instant messaging application is installed on the terminal. The application server is a service backend server of the target application installed on the terminal. For example, the application server may be an application server of an instant messaging application. The application server can interact with the terminal and the operation platform in the local dynamic page generation system to generate a local dynamic page. The operation platform is a third-party platform that is independent of the application server and the terminal. The operation platform is a platform for an operator to configure information. On the operation platform, the operator may configure service package names of all to-be-recommended information. The local dynamic page generation method in this embodiment of the present disclosure is described below by using an example in which the local dynamic page generation system includes at least a terminal, an application server, and an operation platform.

This embodiment of the present disclosure may be applied to the following scenario: An instant messaging application is installed on the terminal, and when the user performs operations in the instant messaging application, different pages will be displayed. In order to enhance the diversity and the flexibility in operating placed information within the instant messaging application, the local dynamic page generation method provided in this embodiment of the present disclosure may be used. The operation platform delivers a service package name of to-be-recommended information (for example, to-be-recommended information) to the server of the instant messaging application, the service package name being configured and generated according to information such as a resource type and a resource address of the to-be-recommended information. In addition, the user may also perform a pull-down refresh operation on a client of the instant messaging application. When receiving the pull-down refresh operation, the client automatically generates an information display request, and transmits the information display request to the server. After receiving the information display request, the server acquires attribute information of the terminal in response to the information display request; and feature information of the user using the terminal can be determined based on the attribute information. In this case, if the attribute information of the terminal matches the to-be-recommended information, the server parses the fields in the service package name to obtain the resource type and resource address; and invokes the local dynamic component corresponding to the resource type and resource address to load the to-be-recommended information to the local display region on the current page (for example, a top region on the current page) of the terminal, to generate a current to-be-displayed page. The page is a local dynamic page. After to-be-displayed page is generated, the terminal displays the page on the client of the instant messaging application, thereby completing a generation process of a local dynamic page in the instant messaging application.

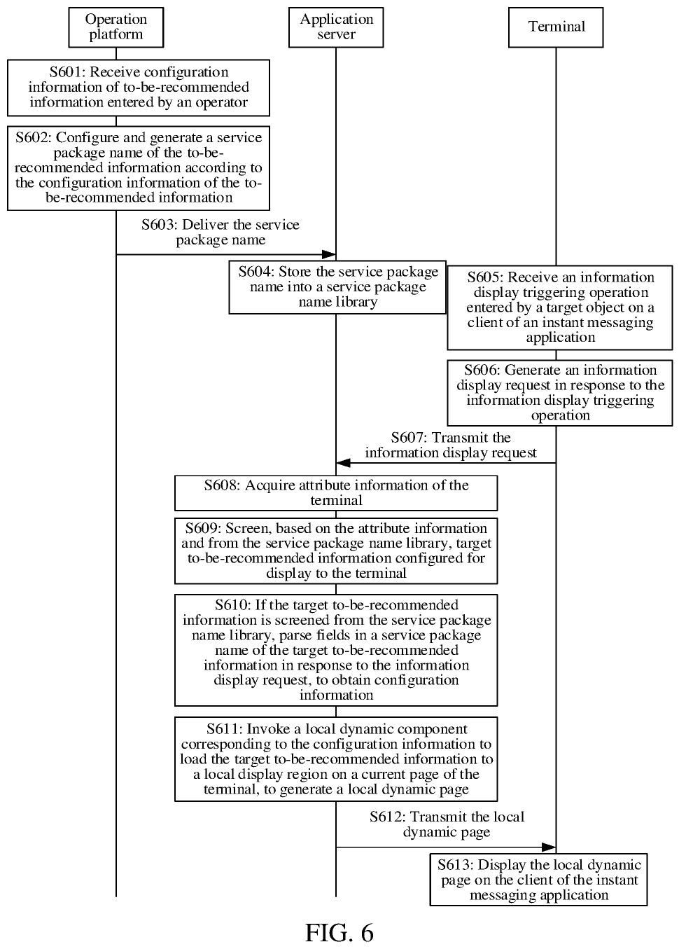

FIG. 6 is another exemplary schematic flowchart of a local dynamic page generation method according to an embodiment of the present disclosure. As shown in FIG. 6, the method includes the following steps:

Step S601: An operation platform receives configuration information of to-be-recommended information entered by an operator.

In this embodiment of the present disclosure, the configuration information of the to-be-recommended information may be information manually entered by the operator. The operator may determine the configuration information according to attribute parameters of the to-be-recommended information, and enter the configuration information on the operation platform. The attribute parameters herein include, but not limited to, at least one of the following: a resource type and a resource address of the to-be-recommended information.

In some embodiments, the operation platform may provide a configuration interface, and there is at least one input position for configuration information on the configuration interface. The operator may enter the configuration information manually or selectively at the input position. The operation platform receives the configuration information entered by the operator.

Step S602: The operation platform configures and generates a service package name of the to-be-recommended information according to the configuration information of the to-be-recommended information.

Herein, configuring and generating the service package name of the to-be-recommended information according to the configuration information of the to-be-recommended information may be sequentially adding, in a field format of the service package name, the configuration information of the to-be-recommended information to specific positions in the field format. For example, for to-be-recommended information of different resource types, field values corresponding to the resource types of the to-be-recommended information may be added to positions corresponding to the resource types in the field format; and for to-be-recommended information of different resource addresses, the resource addresses of the to-be-recommended information may be added to positions corresponding to the resource addresses in the field format.

Step S603: The operation platform delivers the service package name of the to-be-recommended information to an application server.

Step S604: The application server stores the service package name into a service package name library.

The service package name library is a database corresponding to the target application that is configured to store service package names. After the operation platform delivers the service package name to the application server of the target application, it indicates that the operation platform confirms to recommend the to-be-recommended information corresponding to the service package name in the target application. Therefore, the service package name may be stored in the service package name library. When any terminal on which the target application is installed receives an information display triggering operation by the user, the to-be-recommended information may be recommended to the terminal.

There may be a plurality of terminals on which the target application is installed. The same target application has a service package name library, and the service package name library stores service package names of to-be-recommended information for information recommendation to all terminals on which the target application is installed.

For any terminal, for the to-be-recommended information corresponding to the plurality of service package names stored in the service package name library, not every piece of to-be-recommended information can be recommended to the terminal. Therefore, when information recommendation is performed on any terminal and a local dynamic page is generated based on the to-be-recommended information, a service package name of the to-be-recommended information that matches the terminal needs to first screened from the service package name library. In addition, for the same current page, because to-be-recommended information matching different terminals is different, for different terminals, local dynamic pages under the same current page generated based on different to-be-recommended information are different. In this way, personalized local dynamic page generation and personalized information recommendation can be achieved for different users under the same current page.

Step S605: A terminal receives an information display triggering operation entered by a target object on a client of an instant messaging application. The information display triggering operation includes any one of the following: a login triggering operation, a page refresh operation, or an information display request operation.

Herein, the target application is an instant messaging application, and any one of a login triggering operation, a page refresh operation, or an information display request operation performed by the user on the client of the instant messaging application is an information display triggering operation entered by the user. The login triggering operation may be an operation that the user enters a login account and clicks a login button to log in to the application; the page refresh operation may be an operation that the user performs pull-down refresh or clicks a refresh button to refresh the page; and the information display request operation may be an operation that the user clicks an information display button on the current page for an information display request.

Step S606: The terminal generates an information display request in response to the information display triggering operation.

After receiving the information display triggering operation, the client of the instant messaging application on the terminal automatically generates an information display request.

Step S607: The terminal transmits the information display request to the application server.

Step S608: When receiving the information display request, the application server acquires attribute information of the terminal.

Herein, when receiving the information display request transmitted by the terminal, the application server may analyze the terminal that transmits the information display request, to acquire the attribute information of the terminal. In an implementation, the information display request may carry an identifier of the terminal. When receiving the information display request, the application server may parse the information display request, to obtain the identifier of the terminal carried in the information display request, and then determine the attribute information of the terminal according to the identifier of the terminal.

In this embodiment of the present disclosure, the attribute information of the terminal includes, but not limited to: device parameters of the terminal, a time when the target application was installed on the terminal, a use duration of the target application, a login account of the target application, account information of the login account, historical usage data of the login account, and the like. That is, the attribute information of the terminal refers to information that distinguishes the terminal from other terminals. Feature information of the target object using the terminal can be determined based on the attribute information of the terminal.

Step S609: If it is determined that the service package name of the to-be-recommended information is stored in the service package name library, the application server screens, based on the attribute information and from the service package name library, target to-be-recommended information configured for display to the terminal.

Herein, if it is determined that the service package name of the to-be-recommended information is stored in the service package name library, it indicates that the service package name delivered by the operation platform already exists in the current service package name library. Therefore, the target to-be-recommended information can be screened from the service package name library.

In some embodiments, when it is determined that the service package name of the to-be-recommended information is stored in the service package name library, whether the attribute information of the terminal matches the to-be-recommended information can be determined, thereby screening the target to-be-recommended information configured for display to the terminal. An embodiment of the present disclosure provides a method for determining whether the attribute information of the terminal matches the to-be-recommended information, including the following steps: first acquiring historical interaction data of the target object corresponding to the terminal; then performing object feature analysis on the target object according to the historical interaction data, to obtain an object feature of the target object; performing information feature extraction on the to-be-recommended information, to obtain an information feature of the to-be-recommended information; then determining a correlation between the object feature and the information feature; and determining whether the correlation is greater than a correlation threshold, if the determination result is yes, it is determined that the attribute information of the terminal matches the to-be-recommended information; and if the determination result is no, it is determined that the attribute information of the terminal does not match the to-be-recommended information.

Herein, the historical interaction data may be interaction data of the target object within a preset historical time period before a current moment. The interaction in this embodiment of the present disclosure may be any interaction manner, for example, interaction manners such as clicking, commenting, sharing, purchasing, reading, and collecting.

In this embodiment of the present disclosure, portrait analysis may be performed on the target object to determine the object feature of the target object.

During information feature extraction on the to-be-recommended information, summary information of the to-be-recommended information may be extracted, and the summary information may be determined as the information feature of the to-be-recommended information. For example, for to-be-recommended information in a form of text, text identification and text analysis may be performed to determine keywords in the text, and summary information of the text may be determined based on the keywords; and for to-be-recommended information in a form of a picture, picture identification and analysis may be performed, to determine an object in the picture and text in the picture, and the object and the text in the picture are analyzed respectively, to determine summary information of the picture.

During determining of the correlation between the object feature and the information feature, a feature distance between the object feature and the information feature may be calculated, and the feature distance may be determined as the correlation between the object feature and the information feature. A longer feature distance indicates that a weaker correlation between the object feature and the information feature; and a shorter feature distance indicates a stronger correlation between the object feature and the information feature. That is, when the feature distance is greater than a distance threshold, it indicates that the correlation between the object feature and the information feature is less than the correlation threshold; and when the feature distance is less than or equal to the distance threshold, it indicates that the correlation between the object feature and the information feature is greater than or equal to the correlation threshold.

Step S610: If the target to-be-recommended information is screened from the service package name library, the application server parses fields in a service package name of the target to-be-recommended information in response to the information display request, to obtain configuration information.

Herein, if the target to-be-recommended information is screened from the service package name library, it indicates that there is to-be-recommended information for recommendation to the terminal, and therefore the target to-be-recommended information may be recommended to the terminal. During implementation, the application server parses the fields in the service package name of the target to-be-recommended information, to obtain configuration information, and then may generate, based on the configuration information, a local dynamic page configured for displaying the target to-be-recommended information.

Step S611: The application server invokes a local dynamic component corresponding to the configuration information to load the target to-be-recommended information to a local display region on a current page of the terminal, to generate a local dynamic page.

A plurality of types of local dynamic components may be correspondingly configured for the local display region, and each local dynamic component is configured to perform information loading processing on one type of to-be-recommended information. For example, there may be a picture component, an animated picture component, a player component, and a dynamic component, which are respectively configured to load to-be-recommended information of a picture type, an animated picture type, a video type, and a dynamic type. Herein, loading the to-be-recommended information to the local display region on the current page of the terminal means rendering content corresponding to the to-be-recommended information into the local display region, thereby forming a local dynamic page containing the information content of the to-be-recommended information in the local display region.

Step S612: The application server transmits the local dynamic page to the terminal.

Step S613: The terminal displays the local dynamic page on the client of the instant messaging application.

According to the local dynamic page generation method provided in this embodiment of the present disclosure, a service package name of to-be-recommended information that matches the current terminal is screened from a plurality of service package names stored in the service package name library, so that accurate information recommendation can be performed on the current terminal user. In addition, for the same current page, because to-be-recommended information matching different terminals is different, for different terminals, local dynamic pages under the same current page generated based on different to-be-recommended information are different. In this way, personalized local dynamic page generation and personalized information recommendation can be achieved for different users under the same current page. In addition, local display information is configured to invoke the local dynamic component to load local dynamic content, which can not only ensure the overall smoothness of the page, but also can flexibly generate the local dynamic page, thereby enhancing the diversity and the flexibility in operating placed information within the application.

In some embodiments, to enable the operator to dynamically configure and deliver data, and to acquire the accurate service package name of the to-be-recommended information, the application server of the instant messaging application needs to access the operation platform first. The application server may encapsulate the capabilities for requesting the backend service and parsing the return package data into a data processing function package. A new service of the instant messaging application may indirectly transmit an advertising request to the operation platform through the data processing function package. After receiving the advertising request, the operation platform returns data to the data processing function package for parsing, and finally the parsed data is returned to the application server of the instant messaging application. The instant messaging application may display the parsed data. That is, receiving the service package name of the to-be-recommended information delivered by the operation platform may be implemented in the following manner: first acquiring a data processing operation of the terminal, the data processing operation including any request operation that requests the application server to perform data processing and/or any parsing operation that parses return package data of the application server; encapsulating the data processing operation into a data processing function package; then transmitting a to-be-recommended information delivery request to the operation platform through the data processing function package; then receiving operation platform return package data delivered by the operation platform in response to the to-be-recommended information delivery request; and finally parsing the operation platform return package data through the data processing function package, to obtain the service package name of the to-be-recommended information.

Herein, the data processing operations for requesting the application server and parsing the return package data of the application server are encapsulated into a data processing function package. The data processing function package may be a software development kit (SDK), and functions such as data exchange and data parsing and processing with the operation platform is realized through the SDK.

Transmitting the to-be-recommended information delivery request to the operation platform is used for requesting the operation platform to deliver the service package name of the to-be-recommended information. The operation platform return package data includes the service package name of the to-be-recommended information.

In this embodiment of the present disclosure, an SDK that integrates functions such as data exchange and data parsing and processing may be formed through data encapsulation, so that requesting, receiving, and parsing of the service package name of the to-be-recommended information are implemented based on the SDK, thereby greatly reducing the data processing volume of the application server, and improving the efficiency of local dynamic page generation.

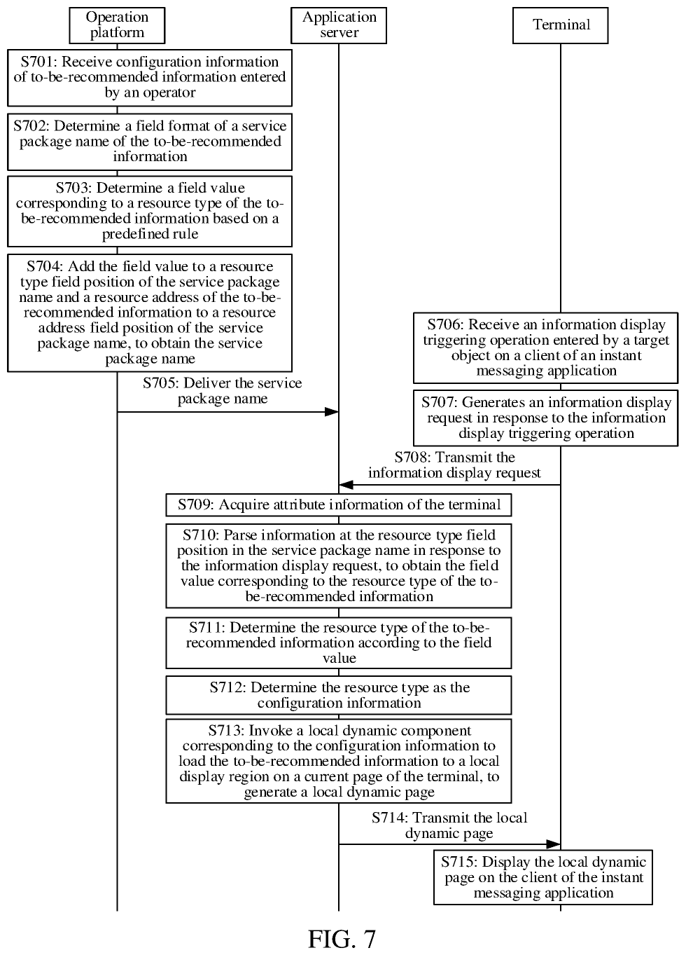

FIG. 7 is still another exemplary schematic flowchart of a local dynamic page generation method according to an embodiment of the present disclosure. As shown in FIG. 7, the method includes the following steps:

Step S701: An operation platform receives configuration information of to-be-recommended information entered by an operator.

Step S702: The operation platform determines a field format of a service package name of the to-be-recommended information.

For different to-be-recommended information, field formats of service package names may be the same or different. The field formats of the service package names of different to-be-recommended information may be predefined. Alternatively, for to-be-recommended information of different recommendation systems, field formats of service package names are different; and for to-be-recommended information of the same recommendation system, field formats of service package names are the same. The field format of the service package name is a package name format of the service package name. Based on the field format, a service package name corresponding to a piece of to-be-recommended information may be obtained through data filling.

Step S703: The operation platform determines a field value corresponding to a resource type of the to-be-recommended information based on a predefined rule.

Herein, the predefined rule refers to a rule that defines field values corresponding to different resource types. For example, for different resource types, field values are different. Each field value represents one resource type to be delivered. If a field value of a resource type is 0, it indicates that corresponding to-be-recommended information is a picture type; if a field value of a resource type is 1, it indicates that corresponding to-be-recommended information is an animated picture type; if a field value of a resource type is 2, it indicates that corresponding to-be-recommended information is a video type; and If a field value of a resource type is 3, it indicates that corresponding to-be-recommended information is an interactive type.

Step S704: The operation platform adds, in the field format, the field value to a resource type field position of the service package name and a resource address of the to-be-recommended information to a resource address field position of the service package name, to obtain the service package name.

In this embodiment of the present disclosure, the configuration information of the to-be-recommended information includes: a resource type of the to-be-recommended information and a resource address of the to-be-recommended information.

Step S705: The operation platform delivers the service package name of the to-be-recommended information to an application server.

Step S706: A terminal receives an information display triggering operation entered by a target object on a client of an instant messaging application.

The information display triggering operation includes any one of the following: a login triggering operation, a page refresh operation, or an information display request operation.

Step S707: The terminal generates an information display request in response to the information display triggering operation.

Herein, an operation type of the user's information display triggering operation may be determined. If the operation type of the information display triggering operation is a preset type, an information display request may be generated, to request the server to generate a final local dynamic page.

In some embodiments, the preset type may be any one or more of a login triggering type, a page refresh type, an information display request type, or the like.

Step S708: The terminal transmits the information display request to the application server.

Step S709: When receiving the information display request, the application server acquires attribute information of the terminal.

In this embodiment of the present disclosure, the information display request may carry an identifier of the terminal. When receiving the information display request, the application server may parse the information display request, to obtain the identifier of the terminal carried in the information display request, and then determine the attribute information of the terminal according to the identifier of the terminal.

Step S710: If the attribute information of the terminal matches the to-be-recommended information, the application server parses information at the resource type field position in the service package name in response to the information display request, to obtain the field value corresponding to the resource type of the to-be-recommended information.

Herein, if the attribute information of the terminal matches the to-be-recommended information, it indicates that the to-be-recommended information is information that can be recommended to the terminal. In this case, because the field format of the service package name of the to-be-recommended information is known, the information configured for filling the resource type field position of the resource type in the field format may be parsed to obtain the field value corresponding to the resource type of the to-be-recommended information.

Step S711: The application server determines the resource type of the to-be-recommended information according to the field value.

Herein, for different resource types, field values are different. Each field value represents one resource type to be delivered. If a field value of a resource type is 0, it indicates that corresponding to-be-recommended information is a picture type; if a field value of a resource type is 1, it indicates that corresponding to-be-recommended information is an animated picture type; if a field value of a resource type is 2, it indicates that corresponding to-be-recommended information is a video type; and If a field value of a resource type is 3, it indicates that corresponding to-be-recommended information is an interactive type.

Step S712: The application server determines the resource type as the configuration information.

Step S713: The application server invokes a local dynamic component corresponding to the configuration information to load the to-be-recommended information to a local display region on a current page of the terminal, to generate a local dynamic page.

Herein, different resource types correspond to different types of local dynamic components, and each type of local dynamic component is configured to perform information loading processing on the corresponding type of to-be-recommended information. For example, if the resource type of the to-be-recommended information is the picture type, a picture component may be invoked to load the to-be-recommended information to the local display region on the current page of the terminal; if the resource type of the to-be-recommended information is the animated picture type, an animated picture component may be invoked to load the to-be-recommended information to the local display region on the current page of the terminal; if the resource type of the to-be-recommended information is the video type, a video component may be invoked to load the to-be-recommended information to the local display region on the current page of the terminal; and if the resource type of the to-be-recommended information is the interactive type, an interactive component may be invoked to load the to-be-recommended information to the local display region on the current page of the terminal.

In some embodiments, the generating a local dynamic page in step S713 may be implemented through the following steps: first invoking a local dynamic component corresponding to the resource type to parse the information at the resource address field position in the service package name, to obtain the resource address of the to-be-recommended information, where the resource address herein may be a uniform resource locator (URL) address; then acquiring an information resource corresponding to the to-be-recommended information according to the resource address; and finally loading the information resource to the local display region on the current page of the terminal.

In some embodiments, there may be at least one resource type, and there may also be at least one local display region on the current page. Therefore, before loading the information resource to the local display region on the current page of the terminal, the method may further include the following step: predefining at least one local display region on the current page. In this way, when the information resource is loaded to the local display region on the current page of the terminal, a target display region configured for displaying the to-be-recommended information may be first determined from the at least one local display region; and then the information resource may be loaded to the target display region.

In some embodiments, there may be at least one resource type; and before the invoking a local dynamic component corresponding to the resource type to parse information at the resource address field position in the service package name, the method may further include the following step: setting a component tag of a local dynamic component corresponding to each resource type for each local display region. In this way, when the local dynamic component corresponding to the resource type is invoked to parse the information at the resource address field position in the service package name, after the target display region configured for displaying the to-be-recommended information is determined, a target component tag of the local dynamic component corresponding to the resource type in the target display region may be determined; then the local dynamic component corresponding to the target component tag may be invoked to parse the information at the resource address field position in the service package name, to obtain the resource address of the to-be-recommended information.

In some embodiments, the resource type of the to-be-recommended information includes at least any one of the following: a picture type, an animated picture type, a video type, or an interactive resource type.

In some embodiments, the local display region may be located in a half-screen pop-up window on the current page.

Step S714: The application server transmits the local dynamic page to the terminal.

Step S715: The terminal displays the local dynamic page on the client of the instant messaging application.

According to the local dynamic page generation method provided in this embodiment of the present disclosure, different types of local dynamic components are preset, and for different types of to-be-recommended information, different local dynamic components are used to perform information loading, which can realize accurate information loading processing in the local display region for various types of to-be-recommended information, to obtain a more accurate local dynamic page.

The following describes an exemplary application of this embodiment of the present disclosure in an actual application scenario.

At present, in order to meet the needs of rapid iteration, a growing number of applications (APPs) use the dynamic technology on some pages with relatively high real-time requirements. However, in many cases, dynamization the entire page is not required. For example, for an advertising placement position on an APP, in many cases, the advertisement is only displayed in a certain part of the entire page. This solution provides a method that can be configured and delivered by operation for displaying a dynamic advertisement at a certain local position on a terminal page. A front-end service package name of an advertisement to be displayed is configured by the operation, and the front-end display service may be dynamically replaced and modified by a service party, making the displayed content highly flexible. In addition, after the operation delivers the advertisement, a display container of the terminal may dynamically pop up at a preset timing, for example, in a case of an operation such as login or pull-down refresh by the user. This solution greatly enhances the diversity and the flexibility in operating placed advertisements within the APP.

The local dynamic page generation method provided in the embodiments of the present disclosure may be applied at least to an instant messaging application. An operator of the instant messaging application may configure a front-end development package that the operator intends to display at a local position on the operation platform, and then deliver configuration data to a user of the instant messaging application. The user of the instant messaging application may trigger pulling of an advertisement (that is, to-be-recommended information) when performing operations such as pull-down refresh, and disconnection and reconnection, so that a half-screen pop-up window will pop up in a main message list of the instant messaging application. There is a region for displaying carousel images in the pop-up window. If content placed and displayed on a certain page of the carousel images is an interactive type, the content displayed on the carousel page is exactly the interactive content configured by the operator. From an operational perspective, the flexibility and the diversity of advertising placement are increased; and from a user perspective, the user can acquire the latest advertising content in real time, making the interactive experience optimal.

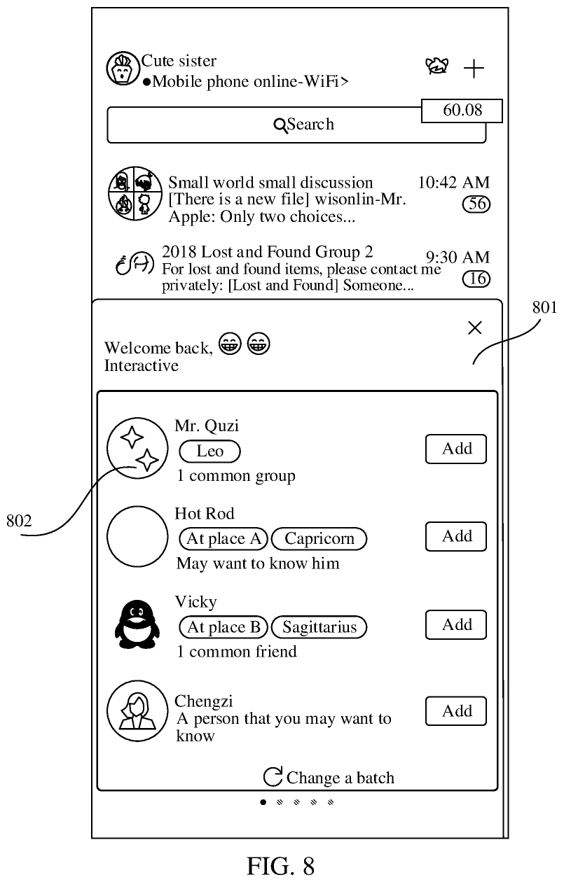

According to the local dynamic page generation method in the embodiments of the present disclosure, on a product side, when the user opens the instant messaging application on the mobile phone and stays on a chat list page, a pull operation for pop-up window display may be triggered by operations such as pull-down refresh or disconnection and reconnection. FIG. 8 is a schematic diagram of a local dynamic advertisement displayed in a pop-up window according to embodiment of the present disclosure. In this case, a half-screen pop-up window 801 pops up at the bottom of the chat list. Advertisement content 802 displayed in this half-screen pop-up window is data configured by operation. If the configured advertising data is an interactive type, replacement may be performed by dynamically delivering different service package names, which is highly flexible. For example, the interactive content herein may display logic such as a person that may be known and daily check-in pulled from the recommendation side. In addition to interactive logic, some other commonly used components such as a picture component, an animated picture component, and a video component are further preset in the half-screen pop-up window. The operation may determine the page to be displayed by configuring the data type and resource content to be displayed on different carousel pages. In this way, the terminal user can immediately acquire the latest advertisement and activity information that the operator intends to push to the user, and the types of advertisements to be displayed are also greatly enriched.

For the operator, advertising content may be dynamically delivered through a placement system (that is, an operation platform). First, material content is created. For a half-screen pop-up window, the material may be interactive logic, a video, a picture, or an animated picture. If the material is interactive logic, a delivered service front-end package name needs to be filled in; if the material is a video, a delivered video URL needs to be filled in; and if the material is a picture or an animated picture, a picture online URL needs to be filled in. After review of the material succeeds, a user level is selectively delivered, and the advertising volume is increased, then the user can receive the latest advertisements delivered by the operation. In addition, on the operation side, the exposure page views (PV) and click PV of each level of advertisements can be acquired to facilitate further real-time analysis.

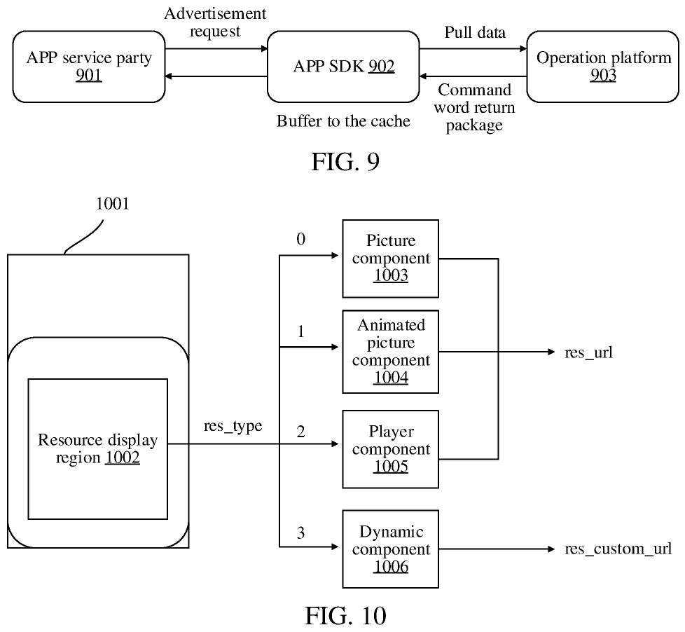

In this embodiment of the present disclosure, to enable the operator to dynamically configure and deliver data, the APP needs to first access the configuration system backend. The APP may encapsulate the capabilities for requesting the backend service and parsing the return package data into an SDK. A new service of the APP may transmit an advertising request to the configuration system backend indirectly through the SDK. After receiving the request, the configuration system returns data to the SDK for parsing, and finally the parsed data is returned to a service party. The service party may perform display. FIG. 9 is a schematic diagram of a request interaction process between an operation platform and an APP according to an embodiment of the present disclosure. As shown in FIG. 9, an APP service party 901 transmits an advertising request to an APP SDK 902. The APP SDK 902 requests an operation platform 903 to pull data. The operation platform 903 returns a command word return package, and the APP SDK 902 buffers the returned command word return package into a cache, and delivers advertising data to the APP service party 901 from the cache.

In this embodiment of the present disclosure, after the APP and the service backend have shared the delivery logic, the operation side needs to stipulate the corresponding fields of the delivered data with the terminal. For example, in the half-screen pop-up window advertising service, dynamically displayed resource types include a picture type, an animated picture type, a video type, an interactive type, and the like. The interactive type displays a front-end local dynamic advertisement. Therefore, it is necessary to define at least the fields shown in Table 1, and there may be four values of resource types. Each value represents a resource type to be delivered. If the delivered resource type corresponds to “0”, “1”, and “2”, the picture/video resource address needs to be delivered simultaneously; if the configured resource type is “3”, the interactive address needs to be delivered simultaneously. The interactive address is usually a front-end service package name. The front-end service herein needs to be uploaded to a corresponding publishing platform after development. After the operation and terminal make communication about the field type, the entire configurable link is established. At this point, the advertising service may be accessed according to needs of a scenario, and the advertising service may be dynamically configured and delivered.

TABLE 1

| | Field | | |
|---|---|---|---|
| Field item | parameter | Type | Value |
| Resource | res_type | Character | [“0”: picture, “1”: animated |
| type | | string | picture, “2”: video, “3”: |
| | | | interactive] |
| Picture/video | res_url | Character | https://xx |
| resource | | string | |
| address | | | |
| Loading state | res_{—} | Character | https://xx |
| placeholder | placeholder | string | |
| image | | | |
| Interactive | res_{—} | Character | VasGuideCirclePoplarVideo |
| address | custom_url | string | |

After the operation delivers the advertisement, an advertisement display container of the terminal may dynamically pop up at a preset timing, for example, in a case of an operation such as login triggering or pull-down refresh by the user. In this embodiment of the present disclosure, a request for advertisement pulling needs to be preset at the corresponding timing (for example, the timing corresponding to an operation such as login triggering or pull-down refresh) on the APP. If the configuration system has the delivered advertising data at this time, the user can pull the corresponding advertising data after triggering the pull request.

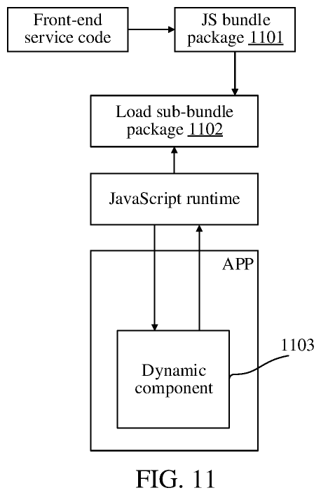

After receiving the advertising data, the terminal parses the delivered field (that is, the service package name). First, a resource type field is parsed, where if it is “0”, a picture component is added to a resource display region, and subsequently the picture component parses a resource link corresponding to a picture/video resource address field; if it is “1”, an animated picture component is added to the resource display region, and subsequently the animated picture component parses a resource link corresponding to the picture/video resource address field; if it is “2”, a player component is added to the resource display region, and subsequently the player component parses a resource link corresponding to the picture/video resource address field; and if it is “3”, a dynamic component is added to the resource display region, and subsequently the dynamic component parses a resource link corresponding to an address field of an interactive address. The dynamic capability in this scenario may be provided by a dynamic framework, and the dynamic component may be hung as a child component on any parent component under any operating system. FIG. 10 is a schematic diagram of display logic of a terminal according to an embodiment of the present disclosure. There is a resource display region 1002 (that is, a local display region) on a terminal APP 1001. The resource display region 1002 corresponds to one parent component, and under the parent component, there are a plurality of corresponding child components, for example, a picture component 1003, an animated picture component 1004, a player component 1005, and a dynamic component 1006 in FIG. 10.

In this embodiment of the present disclosure, an interactive resource configured in the advertisement displays a local dynamic page, which is implemented based on the dynamic technology. The dynamic framework technology may be understood as a browser of a simplified version, which has done a lot of work from the bottom layer, has eliminated double-end differences between different operating systems (for example, iOS and Android), has provided a development experience close to that of the web, and supports both of interface frameworks including React (a JavaScript library for building UIs) and Vue (an open source JavaScript framework for creating UIs, which is also a Web application framework for creating single-page applications). Front-end personnel may use the dynamic framework technology to convert front-end code into the native instructions of the terminal to perform APP development on the native terminal. In addition, a lot of optimizations is generally carried out for dynamic frameworks from the bottom layer, to provide top performance in terms of startup speeds and reusable components. On the terminal, a double-end developer first presets the dynamic component View tag at a certain local position, and then performs initialization work on the dynamic engine while opening the page. FIG. 11 is a schematic diagram of a principle for a terminal to load a front-end data package according to an embodiment of the present disclosure. As shown in FIG. 11, a service front-end data package (that is, the JS bundle 1101 in FIG. 11) is uploaded to a remote server through a packaging system. The dynamic framework loads a remote sub-bundle 1102 through a URL and displays service code on a dynamic View tag 1103 corresponding to the terminal. In addition, provided that a front-end module name (that is, service package name) delivered by the operation side is modified, the front-end service content displayed on the terminal will also change accordingly, thereby realizing the configurable replacement capability of the operation.

In some embodiments, if the operator chooses to deliver an advertisement of an interactive type, the front-end service package name needs to be filled in the interactive resource. In this case, after learning that the delivered data type is an interactive type through reception and parsing, the terminal will select a container to display a dynamic component. In this case, a corresponding JS Bundle service package is then downloaded according to the front-end service package name. After successful loading, a dynamic advertisement can be displayed at the corresponding local position. If the operation configures and changes the data type of the delivered advertisement to a non-interactive type at this time, the display of the dynamic component advertisement can be canceled; and if the operation changes the interactive resource address of the delivered advertisement to another service package name, a JS Bundle of the new service package will be loaded again in the interactive region (that is, the local display region), thereby realizing the pluggability and the dynamic replacement capability of interactive advertisements.

The solution in this embodiment of the present disclosure is a configurable and pluggable local dynamic advertising display solution. On the one hand, the operator may dynamically configure and modify the front-end service package name to dynamically update the advertising content displayed by a terminal component; on the other hand, the content that can be selected to display on the terminal is a local dynamic component, the entire page is developed in a native manner, and the dynamic component is only used in a part with relatively high dynamic requirements, to undertake the delivered dynamic content (that is, to-be-recommended information), thereby making the user experience close to native, and reducing the performance impact caused by use of the dynamic framework.

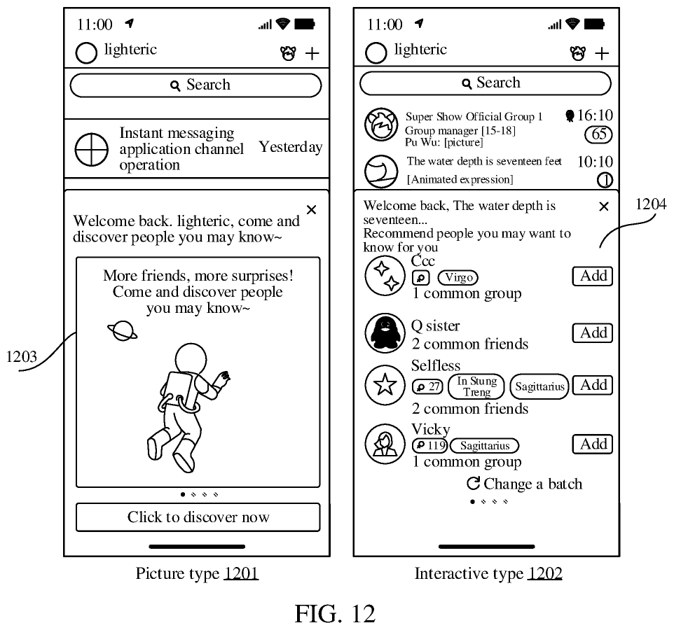

In the solution of this embodiment of the present disclosure, an advertising placement experiment is conducted on an instant messaging application. FIG. 12 is a schematic diagram of different types of control experiments of a local dynamic page generation method according to an embodiment of the present disclosure. User click conversion rates of advertisements of a picture type 1201 and an interactive type 1202 on a half-screen pop-up window 1203 and a half-screen pop-up window 1204 respectively are compared through an experiment. From the background data, the click rate of the picture version is 1.7%, while the click rate of the interactive version is 6.3%. There is an overall increase of more than 3.7 times, proving that this kind of local dynamic advertising is greatly helpful in improving the user click rate.

According to the method in this embodiment of the present disclosure the local dynamic component may be embedded in a half-screen pop-up window, or may be embedded at a specified local position on any terminal page. The local dynamic component provided in the embodiments of the present disclosure may be implemented by using the Hippy framework (a cross-end development framework), which may alternatively be replaced by using other dynamic frameworks.

It may be understood that in the embodiments of the present disclosure, if content related to user information, for example, information such as to-be-recommended information, historical interaction data of a target object, and an object feature of the target object, involves data related to user information or enterprise information, when the embodiments of the present disclosure are applied to specific products or technologies, it is necessary to obtain user permission or consent. In addition, relevant data collection and processing during example application shall be strictly in accordance with the requirements of relevant national laws and regulations, the informed consent or separate consent of personal information subjects shall be acquired, and subsequent data use and processing behaviors shall fall within the scope of authorization by laws, regulations, and personal information subjects.

The following continues to describe an exemplary structure in which the local dynamic page generation apparatus 354 provided in the embodiments of the present disclosure is implemented as software modules. In some embodiments, as shown in FIG. 4, the local dynamic page generation apparatus 354 includes:

a first receiving module, configured to receive a service package name of to-be-recommended information delivered by an operation platform, the service package name being configured and generated according to configuration information of the to-be-recommended information; a second receiving module, configured to receive an information display request transmitted by a terminal, and acquire attribute information of the terminal; a field parsing module, configured to parse, when the attribute information of the terminal matches the to-be-recommended information, fields in the service package name in response to the information display request, to obtain the configuration information; and an information loading module, configured to invoke a local dynamic component corresponding to the configuration information to load the to-be-recommended information to a local display region on a current page of the terminal, to generate a local dynamic page.

In some embodiments, the apparatus further includes: a storage module, configured to: after the service package name of the to-be-recommended information delivered by the operation platform is received, store the service package name into a service package name library; and an attribute information acquisition module, configured to: after the information display request is received, screen, based on the attribute information and from the service package name library, target to-be-recommended information configured for display to the terminal.

In some embodiments, the apparatus further includes: a historical interaction data acquisition module, configured to acquire historical interaction data of a target object corresponding to the terminal within a preset historical time period before a current moment; an object feature analysis module, configured to perform object feature analysis on the target object according to the historical interaction data, to obtain an object feature of the target object; a feature extraction module, configured to perform information feature extraction on the to-be-recommended information, to obtain an information feature of the to-be-recommended information; a correlation determining module, configured to determine a correlation between the object feature and the information feature; and an analysis module, configured to determine, when the correlation is greater than a correlation threshold, that the attribute information of the terminal matches the to-be-recommended information.

In some embodiments, the method is applied to an application server of a target application; and the apparatus further includes: an encapsulation module, configured to acquire a data processing operation of the terminal, the data processing operation being a request operation that requests the application server to perform data processing or a parsing operation that parses return package data of the application server; and encapsulate the data processing operation into a data processing function package; a request transmission module, configured to transmit a to-be-recommended information delivery request to the operation platform through the data processing function package; a return package data receiving module, configured to receive operation platform return package data delivered by the operation platform in response to the to-be-recommended information delivery request; and a parsing module, configured to parse the operation platform return package data through the data processing function package, to obtain the service package name of the to-be-recommended information.

In some embodiments, the configuration information of the to-be-recommended information includes: a resource type of the to-be-recommended information and a resource address of the to-be-recommended information; and the apparatus further includes a configuration module, configured to configure and generate the service package name according to the configuration information of the to-be-recommended information. In some embodiments, the configuration module is further configured to: determine a field format of the service package name of the to-be-recommended information; determine a field value corresponding to the resource type of the to-be-recommended information based on a predefined rule; and add, in the field format, the field value to a resource type field position of the service package name and the resource address of the to-be-recommended information to a resource address field position of the service package name, to obtain the service package name.

In some embodiments, the field parsing module is further configured to: parse information at the resource type field position in the service package name, to obtain the field value corresponding to the resource type of the to-be-recommended information; determine the resource type of the to-be-recommended information according to the field value; and determine the resource type as the configuration information.

In some embodiments, the information loading module is further configured to: invoke a local dynamic component corresponding to the resource type to parse information at the resource address field position in the service package name, to obtain the resource address of the to-be-recommended information; acquire an information resource corresponding to the to-be-recommended information according to the resource address; and load the information resource to the local display region on the current page of the terminal.

In some embodiments, there is at least one resource type; and the apparatus further includes a predefinition module, configured to predefine at least one local display region on the current page; and the information loading module is further configured to: determine, from the at least one local display region, a target display region configured for displaying the to-be-recommended information; and load the information resource to the target display region.

In some embodiments, the apparatus further includes: a tag setting module, configured to set a component tag of a local dynamic component corresponding to each resource type for each local display region; and the information loading module is further configured to: after the target display region configured for displaying the to-be-recommended information is determined, determine a component tag of the local dynamic component corresponding to the resource type as a target component tag in the target display region; and invoke the local dynamic component corresponding to the target component tag to parse the information at the resource address field position in the service package name, to obtain the resource address of the to-be-recommended information.

In some embodiments, the second receiving module is further configured to: receive, when the target object enters an information display triggering operation through the terminal, an information display request transmitted by the terminal in response to the information display triggering operation, the information display triggering operation including any one of the following: a login triggering operation, a page refresh operation, or an information display request operation.

In some embodiments, the resource type of the to-be-recommended information includes at least any one of the following: a picture type, an animated picture type, a video type, or an interactive resource type; and the local display region is located in a half-screen pop-up window on the current page.

Descriptions of the apparatus in this embodiment of the present disclosure are similar to the descriptions of the foregoing method embodiments and have similar beneficial effects as those of the method embodiments, and therefore are not described in detail. For technical details that are not disclosed in this apparatus embodiment, reference may be made to the descriptions of the method embodiments of the present disclosure for understanding.

An embodiment of the present disclosure provides a computer program product or a computer program. The computer program product or the computer program includes executable instructions, the executable instructions being computer instructions; and the executable instructions being stored in a computer-readable storage medium. When a processor of an electronic device reads the executable instructions from the computer-readable storage medium and executes the executable instructions, the electronic device is caused to perform the foregoing method in the embodiments of the present disclosure.

An embodiment of the present disclosure provides a storage medium storing executable instructions. When the executable instructions are executed by a processor, the processor is caused to perform the method provided in the embodiments of the present disclosure, for example, the method shown in FIG. 5.

In some embodiments, the storage medium may be a computer-readable storage medium, for example, a memory such as a ferromagnetic random access memory (FRAM), a read only memory (ROM), a programmable read only memory (PROM), an erasable programmable read only memory (EPROM), an electrically erasable programmable read-only memory (EEPROM), a flash memory, a magnetic surface memory, an optic disc, or a compact disk-read only memory (CD-ROM), or may be any device including one of the foregoing memories or any combination thereof.

In some embodiments, the executable instructions can be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts). For example, the executable instructions may be deployed for execution on one electronic device, execution on a plurality of electronic devices located at one location, or execution on a plurality of electronic devices that are distributed at a plurality of locations and that are interconnected through a communication network.

The foregoing descriptions are merely embodiments of the present disclosure and are not intended to limit the protection scope of the present disclosure. Any modification, equivalent replacement, or improvement made without departing from the spirit and range of the present disclosure shall fall within the protection scope of the present disclosure.

What is claimed is:

1. A local dynamic page generation method, performed by an electronic device, the method comprising:
receiving a service package name of target information to be recommended and delivered by an operation platform, the service package name being configured and generated according to configuration information of the target information;
receiving an information display request transmitted by a terminal;
acquiring attribute information of the terminal;
parsing, when the attribute information of the terminal matches the target information, fields in the service package name in response to the information display request, to obtain the configuration information; and
invoking a local dynamic component corresponding to the configuration information to load the target information to a local display region on a current page of the terminal, to generate a local dynamic page.

2. The method according to claim 1, further comprising:
after the service package name of the target information delivered by the operation platform is received, storing the service package name into a service package name library; and
after the information display request is received, selecting, based on the attribute information and from the service package name library, the target information configured for display to the terminal.

3. The method according to claim 1, further comprising:
acquiring historical interaction data of a target object corresponding to the terminal within a preset historical time period before a current moment;
performing object feature analysis on the target object according to the historical interaction data, to obtain an object feature of the target object;
performing information feature extraction on the target information, to obtain an information feature of the target information;
determining a correlation between the object feature and the information feature; and
determining, when the correlation is greater than a correlation threshold, that the attribute information of the terminal matches the target information.

4. The method according to claim 1, wherein the method is applied to an application server of a target application; and the receiving a service package name of target information delivered by an operation platform comprises:
acquiring a data processing operation of the terminal, the data processing operation being a request operation that requests the application server to perform data processing or a parsing operation that parses return package data of the application server;
encapsulating the data processing operation into a data processing function package;
transmitting a target information delivery request to the operation platform through the data processing function package;
receiving operation platform return package data delivered by the operation platform in response to the target information delivery request; and
parsing the operation platform return package data through the data processing function package, to obtain the service package name of the target information.

5. The method according to claim 1, wherein the configuration information of the target information comprises: a resource type of the target information and a resource address of the target information; and configuring and generating the service package name according to the configuration information of the target information comprises:
determining a field format of the service package name of the target information;
determining a field value corresponding to the resource type of the target information based on a predefined rule; and
adding, in the field format, the field value to a resource type field position of the service package name and the resource address of the target information to a resource address field position of the service package name, to obtain the service package name.

6. The method according to claim 5, wherein the parsing fields in the service package name, to obtain the configuration information comprises:
parsing information at the resource type field position in the service package name, to obtain the field value corresponding to the resource type of the target information;
determining the resource type of the target information according to the field value; and
determining the resource type as the configuration information.

7. The method according to claim 5, wherein the invoking a local dynamic component corresponding to the configuration information to load the target information to a local display region on a current page of the terminal comprises:
invoking a local dynamic component corresponding to the resource type to parse information at the resource address field position in the service package name, to obtain the resource address of the target information;
acquiring an information resource corresponding to the target information according to the resource address; and
loading the information resource to the local display region on the current page of the terminal.

8. The method according to claim 7, wherein the method further comprises: predefining at least one local display region on the current page of the terminal; and
the loading the information resource to the local display region on the current page on the terminal comprises:
determining, from the at least one local display region, a target display region configured for displaying the target information; and
loading the information resource to the target display region.

9. The method according to claim 8, wherein there is at least one resource type; and the method further comprises: setting a component tag of a local dynamic component corresponding to each resource type for each local display region; and
the invoking a local dynamic component corresponding to the resource type to parse information at the resource address field position in the service package name, to obtain the resource address of the target information comprises:
after the target display region configured for displaying the target information is determined, determining a component tag of the local dynamic component corresponding to the resource type as a target component tag in the target display region; and
invoking the local dynamic component corresponding to the target component tag to parse the information at the resource address field position in the service package name, to obtain the resource address of the target information.

10. The method according to claim 1, wherein the receiving an information display request transmitted by a terminal comprises:
receiving, when the target object enters an information display triggering operation through the terminal, an information display request transmitted by the terminal in response to the information display triggering operation,
the information display triggering operation comprising any one of the following: a login triggering operation, a page refresh operation, or an information display request operation.

11. The method according to claim 1, wherein the resource type of the target information comprises at least any one of the following: a picture type, an animated picture type, a video type, or an interactive resource type; and
the local display region is located in a half-screen pop-up window on the current page.

12. A local dynamic page generation apparatus, comprising:
at least one memory, configured to store executable instructions; and at least one processor, configured to, when executing the executable instructions stored in the at least one memory, implement:
receiving a service package name of target information to be recommended and delivered by an operation platform, the service package name being configured and generated according to configuration information of the target information;
receiving an information display request transmitted by a terminal;
acquiring attribute information of the terminal;
parsing, when the attribute information of the terminal matches the target information, fields in the service package name in response to the information display request, to obtain the configuration information; and
invoking a local dynamic component corresponding to the configuration information to load the target information to a local display region on a current page of the terminal, to generate a local dynamic page.

13. The apparatus according to claim 12, wherein the at least one processor is further configured to implement:
after the service package name of the target information delivered by the operation platform is received, storing the service package name into a service package name library; and
after the information display request is received, selecting, based on the attribute information and from the service package name library, the target information configured for display to the terminal.

14. The apparatus according to claim 12, wherein the at least one processor is further configured to implement:
acquiring historical interaction data of a target object corresponding to the terminal within a preset historical time period before a current moment;
performing object feature analysis on the target object according to the historical interaction data, to obtain an object feature of the target object;
performing information feature extraction on the target information, to obtain an information feature of the target information;
determining a correlation between the object feature and the information feature; and
determining, when the correlation is greater than a correlation threshold, that the attribute information of the terminal matches the target information.

15. The apparatus according to claim 12, wherein the apparatus is applied in an application server of a target application; and the receiving a service package name of target information delivered by an operation platform comprises:
acquiring a data processing operation of the terminal, the data processing operation being a request operation that requests the application server to perform data processing or a parsing operation that parses return package data of the application server;
encapsulating the data processing operation into a data processing function package;
transmitting a target information delivery request to the operation platform through the data processing function package;
receiving operation platform return package data delivered by the operation platform in response to the target information delivery request; and
parsing the operation platform return package data through the data processing function package, to obtain the service package name of the target information.

16. The apparatus according to claim 12, wherein the configuration information of the target information comprises: a resource type of the target information and a resource address of the target information; and configuring and generating the service package name according to the configuration information of the target information comprises:
determining a field format of the service package name of the target information;
determining a field value corresponding to the resource type of the target information based on a predefined rule; and
adding, in the field format, the field value to a resource type field position of the service package name and the resource address of the target information to a resource address field position of the service package name, to obtain the service package name.

17. The apparatus according to claim 16, wherein the parsing fields in the service package name, to obtain the configuration information comprises:
parsing information at the resource type field position in the service package name, to obtain the field value corresponding to the resource type of the target information;
determining the resource type of the target information according to the field value; and
determining the resource type as the configuration information.

18. The apparatus according to claim 16, wherein the invoking a local dynamic component corresponding to the configuration information to load the target information to a local display region on a current page of the terminal comprises:
invoking a local dynamic component corresponding to the resource type to parse information at the resource address field position in the service package name, to obtain the resource address of the target information;
acquiring an information resource corresponding to the target information according to the resource address; and
loading the information resource to the local display region on the current page of the terminal.

19. The apparatus according to claim 18, wherein the at least one processor is further configured to implement: predefining at least one local display region on the current page of the terminal; and
the loading the information resource to the local display region on the current page on the terminal comprises:
determining, from the at least one local display region, a target display region configured for displaying the target information; and
loading the information resource to the target display region.

20. A non-transitory computer-readable storage medium, storing executable instructions, and the executable instructions, when being executed by at least one processor, causing the at least one processor to perform:
receiving a service package name of target information to be recommended and delivered by an operation platform, the service package name being configured and generated according to configuration information of the target information;
receiving an information display request transmitted by a terminal;
acquiring attribute information of the terminal;
parsing, when the attribute information of the terminal matches the target information, fields in the service package name in response to the information display request, to obtain the configuration information; and
invoking a local dynamic component corresponding to the configuration information to load the target information to a local display region on a current page of the terminal, to generate a local dynamic page.
